(19) United States
(12) Patent Application Publication
(10) Pub. No.: US 2009/0245294 A1
(43) Pub. Date: Oct. 1, 2009

(54) Fibre Laser with Intra-cavity Frequency Doubling

(75) Inventors: Validimir Alexandrovich Alkulov, (US); Sergei Alexeevich Babin, (US); Sergei Ivanovich Kablukov, Novosibirsk (RU); Dmitry Vladimirovich Churkin, Novosibirsk (RU)

Correspondence Address: THOMAS LOOP, P.O. BOX 21466, SEATTLE, WA, 98111, US

(73) Assignee: Zecotek Laser Systems Pte. Ltd., Singapore (SG)

(21) Appl. No.: 12/182,951

(22) Filed: Jul. 30, 2008

Related U.S. Application Data
(60) Provisional application No. 60/953,141, filed on Jul. 31, 2007.

(51) Int. Cl. H01S 3/30; H01S 3/10

(52) U.S. Cl. 372/6; 372/22

(57) ABSTRACT

The invention disclosed herein relates to fibre lasers with intra-cavity frequency doubling. In one embodiment, the invention is directed to a fibre laser with intra-cavity frequency doubling characterized in that a non-linear crystal of type II phase matching is used to thereby enable operation of the fibre laser without selection of polarisation of the generated fundamental radiation. The non-linear crystal is oriented so as to minimise the walk-off angle of the second harmonic radiation, and a second dichroic mirror together with one of a plurality of focusing elements forms a telescopic reflector that provides for focusing and compensation of the spatial walk-off effect of the non-linear crystal.

### CROSS-REFERENCE TO RELATED APPLICATION

This application claims the benefit of U.S. Provisional Application No. 60/953,141 filed on Jul. 31, 2007, which application is incorporated herein by reference in its entirety for all purposes.

### TECHNICAL FIELD

The present invention relates to laser equipment and, more specifically, to fibre lasers with frequency doubling and with emissions in the visible spectrum range. The inventive fibre lasers may find applications as light sources for various technologies including ultra-high-density optical memory (as well as data recording), colour laser printing, colour laser displays, bio-medical diagnostics (cytometry, DNA sequencing), analytical measurements (Raman spectroscopy, spectro-fluorometry, confocal microscopy), forensic studies, and others.

### BACKGROUND OF THE INVENTION

Fibre lasers belong to a new type of laser in which an optical fibre serves as the active medium. Fibre lasers possess a number of advantages over other types of lasers, advantages that include high beam quality, compact dimensions, stability of output parameters, reliability, absence of water cooling, simplicity of operation, and relatively low cost. These advantages make fibre lasers attractive for various users. Consequently, during the last few years different configurations of fibre lasers have been under development around the world, mostly diode-pumped continuous wave (CW) and pulsed fibre lasers with different output powers on the basis of fibres doped with ions of ytterbium (Yb), neodymium (Nd), erbium (Er) (also with Raman converters), and emitting in the range of wavelengths longer than 1 μm, which already outperform lasers of other types.

For generation in the visible spectrum range, particularly in the blue-green region, it is necessary to double the output frequency of a fibre laser, which is difficult (especially in the CW mode) because of specific polarisation and spectral parameters associated with fibre lasers. Solution to the problem of efficient frequency doubling of fibre lasers will enable CW fibre sources of laser radiation within visible spectral range, specifically blue-green lasers with an output wavelength of 450-570 nm generated by doubling the frequency of the most powerful ytterbium and neodymium fibre lasers, as well as yellow-red lasers with output within 740-810 nm and 550-850 nm on the basis of erbium and Raman fibre lasers.

Efficient, reliable, and compact frequency-doubled fibre lasers will also be able to replace argon lasers, which consume large amounts of power and are difficult to operate. Frequency-doubled fibre lasers will also be able replace dye lasers and single-mode laser diodes for the yellow-red wavelength range.

Efficient frequency doubling in fibre lasers has been demonstrated for pulsed fibre lasers in a limited wavelength range (around 540 and 780 nm) corresponding to the second harmonic of the strongest lines of ytterbium and erbium fibre lasers (see, e.g., R. J. Thompson, M. Tu, D. C. Aveline, N. Lundblad, L. Maleki, High power single frequency 780-nm laser source generated from frequency doubling of a seeded fibre amplifier in a cascade of PPLN crystals, Optics Express, 11(14), 1709 (2003)).

The second harmonic is generated when radiation passes through an external non-linear material, usually a special periodically-poled crystal such as PPLN, PPKTP, and others, in which the walk-off effect is periodically compensated thereby allowing longer crystal lengths. For CW systems in the blue spectral domain, for example, the generation efficiency is very small even for long crystals; namely, 2.7 W of power for a ytterbium laser output (978 nm) to no more than about 18 mW of second-harmonic output (489 nm), which corresponds to a frequency doubling efficiency of about 0.7% (see, D. B. S. Soh, C. Codemard, S. Wang, J. Nilsson, J. K. Sahu, F. Laurell, V. Philippov, Y. Jeong, C. Alegria, S. Baek, A 980-nm Yb-doped fibre MOPA source and its frequency doubling, IEEE Photonics Technology Letters, 16(4), 1032-1034 (2004)).

Moreover, the design of such a laser is very complicated and expensive in that the laser comprises a source of single-frequency linearly-polarised radiation in a MOPA (Master Oscillator-Power Amplifier) configuration and an external single-pass frequency doubler on the basis of a periodically-poled crystal (PPKTP in the specific mentioned case). Within the green and red spectral ranges the conversion efficiency may be higher, however, periodically-poled structures degrade quickly at high powers and are also very expensive.

The intra-cavity configuration for frequency doubling seems to be more efficient since it allows for higher intensities of the fundamental radiation incident on the non-linear crystal. As a result, better conversion efficiencies are possible. Moreover, the intra-cavity configuration is compatible not only with periodically-poled crystals but also with normal standard-length non-linear crystals (such as KTP, LBO, LiNbO₃, KN, BBO, BiBO, etc.) thereby making the system design simpler and cheaper.

Fibre laser radiation is usually polarised chaotically (randomly) and has a broad spectrum mainly determined by the spectral reflection profile of the cavity mirrors (or fibre Bragg gratings). Low spectral power density and random polarisation complicate the problem of efficient frequency doubling when standard fibre lasers are used as the source of fundamental radiation. Nevertheless, there are some patented solutions as well as practical attempts to implement a fibre laser with intra-cavity frequency doubling.

In the description of the invention disclosed in Russian patent no. N2269849, priority of 14 Mar. 2001 (corresponding to European patent no. EP 1241746A1), a solution for a Raman laser with frequency doubling is given. More specifically, this patent suggests that yellow radiation (589 nm) may be generated in a non-linear crystal (second harmonic generator) that is placed inside the resonator of a fibre Raman laser (1178 nm) that consists of an optical fibre and two mirrors: the first mirror is formed by a Bragg grating recorded into the optical fibre itself, whereas the second mirror is positioned in an external free-space outside the fibre. The crystal is placed in the air gap between the fibre and the free-space mirror, a mode-matching lens is inserted between the crystal and the fibre, and a dichroic flat mirror is used to couple the second harmonic radiation out of the cavity. In this configuration there are no polarising and selective elements that generate polarised radiation with narrow spectral width.

In a recent paper (Y. Feng, S. Huang, A. Shirakawa, and K. Ueda, Multiple-color cw visible lasers by frequency sum-mixing in a cascading Raman fiber laser, Opt. Express 12, 1843-1847 (2004)), a practical implementation of the above-mentioned solution was described. More specifically, an LBO crystal with non-critical phase matching placed inside the cavity of a fibre Raman laser was used for frequency doubling. The demonstrated efficiency of conversion from the fundamental output of a ytterbium laser into the second harmonic of the Raman laser was about 0.1%, with the output power coming to saturations and not exceeding the 10-mW level. It is believed that one of the reasons for such a low doubling efficiency is due to the small non-linear coefficient of the LBO crystal (even in the absence of spatial walk-off in non-critical phase matching LBO's conversion efficiency is by an order of magnitude lower than, for example, that of a KTP crystal). Besides, when using type I phase matching only one linear polarisation component of the fibre Raman laser is doubled, resulting for real systems with unpolarised (randomly polarised) radiation a reduction of the second-harmonic output by a factor of 4. The conversion coefficient is additionally reduced by a few times because of the large spectral width of the fundamental radiation (>1 nm) and because of the sub-optimal focusing into the non-linear crystal when a flat mirror is used.

A solution disclosed in U.S. Pat. No. 5,966,391 to Zediker et al. is known in which a configuration of a linearly polarised fibre laser with intra-cavity frequency doubling is suggested. In this configuration the laser includes a long doped (Yb, Er, Nd, etc.) optical fibre placed inside a cavity of dichroic mirrors. The first mirror transmits the pump radiation and reflects the generated radiation (in the about 1.06-μm range), wherein the first mirror may be implemented as a Bragg grating integrated into the optical fibre itself. The second dichroic mirror is implemented as a free-space component that reflects the fundamental harmonic (1.06 μm) and transmits the second-harmonic radiation (0.53 μm). A mode-matching lens and the non-linear crystal are placed in the air gap between the fibre and the coupling free-space mirror similar to the configurations noted above. Additionally, the resonator includes a polarisation selector and a polarisation controller implemented as volumetric or fibre components. As a result, the laser must generate linearly polarised radiation allowing a four-fold increase in the second harmonic output when non-linear crystals with type I phase matching are used. However, in this configuration no measures were taken to increase spectral density of power and, besides, the laser layout including polarisation selection and control is much more complicated than the ones without them (it contains many additional elements and requires active (closed-loop) stabilisation of polarisation state of radiation).

Thus, shortcomings of the prior art solutions for intra-cavity frequency doubling may be summarised as follows: (1) no measures have been taken to increase spectral power density by narrowing of radiation spectrum and optimisation of radiation focusing into the non-linear crystal; and (2) application of non-linear crystals with type I phase matching (e.g., LBO) or periodically-poled crystals (such as PPLN, PPKTP) requires linearly polarised fundamental radiation, the fibre laser design with polarisation selection and control at the fundamental frequency becoming very complicated, and however the simple and reliable unpolarised laser design is possible, but only with frequency doubling efficiency by a factor of 4 lower. When using non-linear crystals with type II phase matching (e.g., KTP) it is necessary to have two orthogonal linear polarisations (or random polarisation as in conventional fibre lasers) and the conversion efficiency is limited by the spatial walk-off effect, which does not allow using long crystals and optimal focusing of the radiation into the crystal.

The present invention is aimed at the creation of a fibre laser with intra-cavity frequency doubling on the basis of a simple unpolarised configuration, and in spite of that delivering high frequency doubling efficiency (at least as good as that delivered by a complicated polarised configuration).

This problem is solved by using a special arrangement for focusing into a crystal with type II phase matching (e.g. KTP) and additional spectral selection, which makes it possible to increase the spectral power density of radiation, to use both orthogonal polarisation components of the radiation, and to reduce the spatial walk-off effect.

This solution enables a simple, reliable, and cost-effective fibre light source in the blue-green spectral range with improved, as compared to existing analogues, technical parameters and convenience of use, which will extend the area of application of such lasers.

### SUMMARY OF THE INVENTION

The present invention relates to a fibre laser with intra-cavity frequency doubling that includes pump source, active optical fibre placed inside a resonator formed by two dichroic mirrors, the first of which transmits the pump radiation and reflects the generated fundamental radiation, and the second of which is positioned outside the optical fibre and reflects the fundamental radiation, a non-linear crystal placed between the optical fibre and the second mirror, and focusing elements, a non-linear crystal with type II phase matching is used and oriented in such a way as to minimise the walk-off angle for the generated wavelength, a spectral selector is introduced between the optical fibre and the non-linear crystal for narrowing of the output spectrum and stabilisation of the output power, which is implemented either as a fibre Bragg grating written into the end of the optical fibre, a free-space or fibre filter or interferometer, and a third dichroic mirror is introduced, which reflects the fundamental radiation and transmits the second harmonic, whereas the second dichroic mirror reflects both the fundamental radiation and the second harmonic, and together with an additional focusing element forms a telescopic reflector that provides for optimal focusing and for compensation of the spatial walk-off effect in the non-linear crystal.

The above-described configuration is optimal, other versions of the laser are also proposed, which are aimed at achievement of various component technical effects.

For example, and in one embodiment the present invention is directed to a fibre laser with intra-cavity frequency doubling, comprising: a pump source for generating pump radiation; a doped optical fibre optically coupled to the pump source and positioned within a resonator formed by first and second dichroic mirrors, wherein the first dichroic mirror is configured to allow passage of the pump radiation and reflect a generated fundamental radiation, and wherein the second dichroic mirror is positioned outside the optical fibre and is configured to reflect the generated fundamental radiation; a non-linear crystal positioned between the optical fibre and the second dichroic mirror; and a plurality of focusing elements optically coupled to the fibre laser; characterized in that the non-linear crystal is of type II phase matching thereby enabling operation of the fibre laser without selection of polarisation of the generated fundamental radiation, and wherein the non-linear crystal is oriented so as to minimise the walk-off angle of the second harmonic radiation, and wherein the second dichroic mirror together with one of the plurality of focusing elements forms a telescopic reflector that provides for focusing and compensation of the spatial walk-off effect of the non-linear crystal.

In another embodiment the present invention is directed to a fibre laser with intra-cavity frequency doubling, comprising: a pump source for generating pump radiation; a doped optical fibre optically coupled to the pump source and positioned within a resonator formed by first and second dichroic mirrors, wherein the first dichroic mirror is configured to allow passage of the pump radiation and reflect a generated fundamental radiation, and wherein the second dichroic mirror is positioned outside the optical fibre and is configured to reflect the generated fundamental radiation; a non-linear crystal positioned between the optical fibre and the second dichroic mirror; and a plurality of focusing elements optically coupled to the fibre laser; characterized in that the non-linear crystal is of type II phase matching thereby enabling operation of the fibre laser without selection of polarisation of the generated fundamental radiation, and wherein the non-linear crystal is oriented so as to minimise the walk-off angle of the second harmonic radiation, and wherein a spectral selector configured to narrow the radiation spectrum and stabilise the output power is positioned between the optical fibre and the non-linear crystal, and wherein a third cavity-folding output dichroic mirror configured to reflect the generated fundamental radiation and allow passage of the second harmonic radiation is also positioned between the optical fibre and the non-linear crystal, and wherein the second dichroic mirror together with one of the plurality of focusing elements forms a telescopic reflector that provides for focusing and compensation of the spatial walk-off effect of the non-linear crystal.

These and other aspects of the present invention will become more evident upon reference to the following detailed description and attached drawings. It is to be understood, however, that various changes, alterations, and substitutions may be made to the specific embodiments disclosed herein without departing from their essential spirit and scope. In addition, it is expressly provided that all of the various references cited herein are incorporated herein by reference in their entireties for all purposes.

### BRIEF DESCRIPTION OF THE DRAWINGS

The laser description is clarified by FIG. 1 where the proposed and implemented design of the fibre laser with intra-cavity frequency doubling is demonstrated.

FIG. 1 is a schematic representation of a fibre laser with intra-cavity frequency doubling in accordance with an embodiment of the present invention, wherein LD—laser diode pump, PC—pump multiplexer/coupler, M₁—the first dichroic mirror, M₂—the second dichroic mirror, M₃—the third dichroic mirror, DF—active (doped) optical fibre, S—narrow-band spectral selector, L₁—the first focusing lens, L₂—the second focusing lens, L₃—the third focusing lens, NC—non-linear crystal with type II phase matching (e.g. KTP) placed in a thermostat with temperature control T°.

FIG. 2 is a schematic representation of a telescopic reflector portion of a fibre laser with intra-cavity frequency doubling in accordance with an embodiment of the present invention.

### DETAILED DESCRIPTION OF INVENTION

For frequency doubling a KTP crystal with high conversion efficiency and a possibility to use both polarisations was chosen. KTP crystal (d_{eff}=3.88 pm/V) allows using unpolarised (randomly polarised) radiation of an Yb fibre laser even when the generation spectrum is about 1 nm wide. This is four times as good in spectral parameters as compare to periodically poled crystals PPLN (d_{eff}=16 pm/V) and PPKTP (d_{eff}=5.3 pm/V), which both require linear polarisation for operation. However, the conversion coefficient for KTP is somewhat lower than that for PPKTP (d_{eff}²=15 and 28, correspondingly); moreover, when unpolarised radiation is used it becomes twice as large as the one for PPKTP.

Traditionally, KTP is used for type II phase matching (oe→e or oe→o) within a wavelength range of around 1 μm, in which case even a small spatial walk-off of the extraordinary wave e considerably reduces the efficiency of the second-harmonic generation (see, e.g., J.-J. Zondy, Comparative theory of walkoff-limited type-II versus type-I second-harmonic generation with Gaussian beams, Opt. Commun. 81, 427-440 (1991)). The walk-off angle for the traditional Nd laser wavelength 1064 nm is 4 mrad, whereas for the experiments implemented by us the wavelength 1085 nm the walk-off angle amounts to 10 mrad. For estimation of the reduction in conversion efficiency the walk-off parameter B=ρ(k_{ω}L)^{1/2}/2 is traditionally used, where ρ is the walk-off angle, k_{ω} is the wave vector of the fundamental radiation in the crystal, and L is the crystal length. Parameter B equals 0.63 and 1.7 for a 10-mm crystal and the above-mentioned walk-off values respectively. According to the data published in the cited paper, the reduction in the conversion coefficient amounts to factors of 2 and 7 respectively.

The reduction of the conversion coefficient can, to a certain extent, be compensated by way of oblique incidence of the pumping beam on the crystal, bi-refringence and vector phase matching being used in this case.

The crystal used in our experiments was cut for critical collinear phase matching at 3.7° to the crystallographic axis (XZ at 60° C.). The optimal cut angle may vary within the range of between 0° to 20° depending on the wavelength (1079 to 1110 nm respectively). With the crystal cut angle of 3.7° at λ=1085 nm the difference between phase matching angles when the angle of incidence changed from normal to either side amounted to +3° and −17°, respectively. Walk-off angles of the orthogonally polarised pumping beam amounted to +8.7 and −2.4 mrad, respectively. As a result of smaller walk-off angle for the pumping beams, the conversion efficiency for the larger incident angle to the normal exceeds by a factor of 2 that for the smaller incident angle and amounted to about 10⁻³ 1/W. According to Z. Ou et al. (see, Z. Ou, S. Pereira, E. Polzik, and H. Kimble, 85% efficiency for cw frequency doubling from 1.08 to 0.54 μm, Opt. Lett. 17, 640-642 (1992)), the optimal conversion coefficient in the absence of spatial walk-off is about 2×10⁻³ 1/W for a 10-mm crystal. Thus, we succeeded in improving the conversion coefficient considerably.

In addition to reducing the efficiency of conversion, spatial walk-off leads to the formation of two parallel pumping beams with orthogonal polarisation after passing through the crystal. This condition makes it difficult to use the non-linear crystal inside the laser cavity. A conventional solution to this problem would be to use a flat mirror to send the backward beam along the same path (see, e.g., European patent no. EP 1241746A1 noted above). However, this leads to a shift of the focus point outside the crystal, thereby significantly reducing the coefficient of conversion into the second harmonic.

An original telescopic “lens-mirror” reflector has also been invented that allows for optimal focusing into the crystal for both polarisations and at the same time sending both beams (with orthogonal polarisations) back each along the same path.

A beam propagation schematic diagram is shown in FIG. 2 where NC—type II non-linear crystal (e.g. KTP), f—focal length of the lens, R—mirror curvature radius, d—distance to the waist of the returning beam. Solid and dashed lines correspond to propagation of the ordinary and extra-ordinary beams accordingly, whereas dotted lines show how the beam size changes as it travels along the system.

Additionally, calculations of the reflector with Gaussian beams were carried out with the help of paraxial matrix approximation (ABCD-matrix). Results have shown that the proposed reflector has yet another useful property; namely, it reflects a Gaussian beam back without any change in the size and position of the beam waist. The distance to the waist d of the returned beam is determined by the parameters of the reflector and does not depend on the size of the beam: d=(f+R)·f/R. This allows implementation of a double-pass conversion system with optimal matching of the fundamental and second-harmonic beams, and because of this a two-fold improvement in the efficiency of conversion.

Among the advantages of fibre lasers (for example, over solid-state lasers) are the possibility of smooth output frequency detuning within dozens of nanometres and generation of tuneable radiation in the second harmonic, for example, in the range of 480-570 nm in the case of a ytterbium fibre laser. From the view-point of tuneability, the chosen crystal orientation also has advantages over the use of non-critical temperature phase matching, which has a limited wavelength range of about 539-541 nm at practical temperatures.

Other elements have the following functions.

Mirrors M₁, M₂, and M₃ form the resonator allowing fundamental laser generation in the mentioned range. Dichroic mirror M₁ is transparent to the pump radiation and reflects the fundamental wave; this mirror may be formed directly inside the fibre as a Bragg grating with a relatively narrow reflection spectrum (0.03-1 nm) also allowing wavelength detuning by application of tension or compression to the stretch of fibre where the grating is recorded.

For spectrum narrowing an additional spectral selector S may be introduced inside the resonator, the selector consisting of a narrow-band filter or interferometer (fibre-based or volumetric). In the case of a fibre-optic design the selector may be based on fibre Bragg grating(s); as an alternative modification, it is possible to integrate the selector with mirror Mₗ or M₃.

Dichroic mirror M₂ is implemented as a volumetric (free-space) optical element having spectral parameters, which provide high reflectivity both at the fundamental wavelength and at the second harmonic one. Coupling of the generated second-harmonic radiation is performed through the dichroic cavity-folding mirror M₃ having a high reflection coefficient at the fundamental frequency and transparent for the second harmonic—in this case the second harmonic power generated in two passes of high-intensity intra-cavity radiation through the non-linear crystal adds together.

It is possible to integrate mirrors M₂ and M₃ in one element, namely, an output mirror transparent to the second harmonic. In this case the system will be simpler but its efficiency will be reduced by a factor of 2.

The non-linear crystal (e.g. KTP) generally is chosen in such a way as to provide type II phase matching and the smallest angle of spatial walk-off (for example, by way of oblique incidence of the radiation on the crystal, as described earlier)—this allows utilisation of the entire intensity of unpolarised (randomly polarised) radiation decomposed into two orthogonal linear polarisation and, thereby, a four-fold improvement in efficiency and, additionally, improvement of the conversion coefficient because of the possibility to use a longer non-linear crystal.

In order to reduce the effect of residual walk-off and to optimize beam focusing into the non-linear crystal a special lens-mirror telescope aqs shown in FIG. 2 is used for reflecting both orthogonal polarisations back into the optical fibre and also for better alignment of the waves generated in the forward and backward passes through the crystal. Modifications are possible using KTP with non-critical phase matching for a limited wavelength range of around 540 nm. The use of other crystals are also possible.

The active optical fibre can be a standard single-mode fibre with the size of the glass cladding ranging from about 100-400 μm and the core diameter ranging from about 3-10 μm (as well as multi-mode, gradient, micro-structured, composite—GTW type and others) doped with Yb as well as with other rare-earth elements (correspondingly, the working spectral range of mirrors, selector, and crystal is changed). Additionally, the fibre core may have an enlarged mode diameter (10-100 μm) thereby reducing coupling losses introduced when radiation is guided into the fibre through the lens system L₁ and L₂ and also allowing the use of aspherical, gradient, and micro-lenses, as well as usual short-focus lenses. Besides, a larger beam diameter within the active fibre reduces local intensity of the fundamental radiation and, consecutively, lowers saturation of the gain medium and non-linear effects (which lead to spectrum broadening) at a given power level, hence improving the efficiency of conversion into the second harmonic.

### Operation of the Device

Radiation from one or more pumping laser diodes LD (emitting at wavelengths of about 976, 915, or 808 nm) is guided directly or through a pump combiner PC into the active optical fibre DF (doped with Yb, Nd, or Er) and creates gain for optical signal propagating along the optical fibre within the gain band of the fibre (for ytterbium-doped fibre it is usually within 0.97-0.98 μm and 1.03-1.15 μm, 0.9-1.1 μm for Nd-doped fibre, and 1.48-1.62 μm for Er-doped fibre).

The amplified signal with the wavelength within the specified spectral range propagates along the resonator formed by the optical fibre and mirrors M₁, M₂, and M₃ through the intra-cavity elements (selector S, lenses L₁₋₃, and non-linear crystal NC) such that as the signal gain within the active fibre exceeds full losses in the resonator, laser generation is established for the fundamental radiation. The selector reflects partially the fundamental radiation and narrows its spectrum, lenses L₁ and L₂ focus the beam passing through them approximately into the middle of non-linear crystal NC, and the beam is then reflected back (and at the same time again focused into the middle of non-linear crystal NC) by the telescopic reflector formed by mirror M₂ and lens L₃. As this process goes on, the second-harmonic radiation is generated within the crystal because of non-linear light conversion (both during forward and backward passes), which is then collimated by mirror M₂ and coupled out of the cavity through mirror M₃.

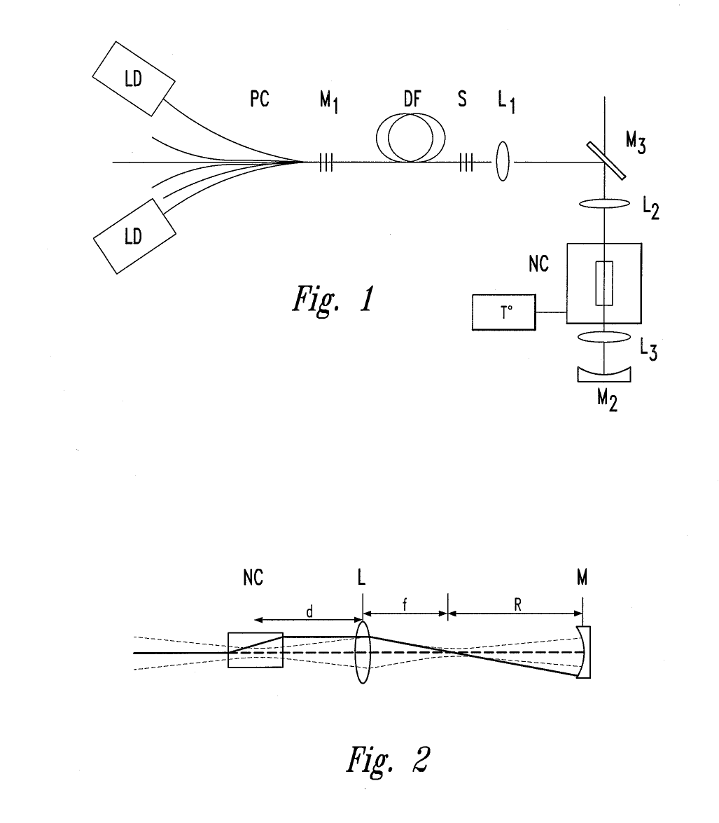

The present design was realised (FIG. 1) for the specific case of a KTP crystal oriented according to the description presented earlier. The efficiency of conversion into the second harmonic was about 5%, being an order of magnitude higher than that demonstrated by the previously noted analogues. The output power in the implemented device (generated up to about 0.5 W at 542.5 nm) grew linearly as the pump (laser diode output) power was increased, which indicates the possibility to further raise the second harmonic power by increasing the pump power.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

What is claimed is:

1. A fibre laser with intra-cavity frequency doubling, comprising:
a pump source for generating pump radiation;
a doped optical fibre optically coupled to the pump source and positioned within a resonator formed by first and second dichroic mirrors, wherein the first dichroic mirror is configured to allow passage of the pump radiation and reflect a generated fundamental radiation, and wherein the second dichroic mirror is positioned outside the optical fibre and is configured to reflect the generated fundamental radiation;
a non-linear crystal positioned between the optical fibre and the second dichroic mirror; and
a plurality of focusing elements optically coupled to the fibre laser;
characterized in that the non-linear crystal is of type II phase matching thereby enabling operation of the fibre laser without selection of polarisation of the generated fundamental radiation, and wherein the non-linear crystal is oriented so as to minimise the walk-off angle of the second harmonic radiation, and wherein the second dichroic mirror together with one of the plurality of focusing elements forms a telescopic reflector that provides for focusing and compensation of the spatial walk-off effect of the non-linear crystal.

2. The fibre laser according to claim 1 wherein the non-linear crystal is a potassium titanium oxide phosphate (KTP) crystal.

3. The fibre laser according to claim 1 wherein the non-linear crystal is cut at an angle ranging from about 0° to 20° relative to the crystallographic axis of the non-linear crystal so as to allow for critical collinear phase matching.

4. The fibre laser according to claim 1 wherein the pump source comprises one or more laser diodes emitting at wavelengths of about 976 nm, 915 nm, or 808 nm, and wherein the output of the one or more laser diodes is guided into the optical fibre through a pump combiner.

5. The fibre laser according to claim 1 wherein the first dichroic mirror is integrated into the optical fibre as a fibre Bragg grating having a reflection spectrum ranging from about 0.03 nm to about 1 nm, and wherein the fibre Bragg grating is configured to allow for detuning of radiation wavelength either by application of (i) tension or compression to the part of the optical fibre where the fibre Bragg grating is positioned, or (ii) a temperature change to the fibre Bragg grating.

6. The fibre laser according to claim 1 wherein the optical fibre has a core diameter ranging from about 3 μm to about 100 μm.

7. The fibre laser according to claim 1 wherein the plurality of focusing elements include an aspherical lens, a gradient lens, a micro-lens, or a short-focus lens.

8. The fibre laser according to claim 1, further comprising:
a spectral selector configured to narrow the radiation spectrum and stabilise the output power positioned between the optical fibre and the non-linear crystal, wherein the spectral selector is either a Bragg grating integrated into the optical fibre's end, a filter, or an interferometer.

9. The fibre laser according to claim 1, further comprising:
a third cavity-folding output dichroic mirror configured to reflect the generated fundamental radiation and allow passage of the second harmonic radiation positioned between the optical fibre and the non-linear crystal, and wherein the second dichroic mirror is configured to reflect both the generated fundamental radiation and the second harmonic radiation.

10. The fibre laser according to claim 9 wherein one of the plurality of focusing elements is positioned between the third cavity-folding output dichroic mirror and the non-linear crystal.

11. The fibre laser according to claim 9, further comprising a narrow-band spectral selector integrated into the first, second, or third dichroic mirrors.

12. The fibre laser according to claim 1 wherein the telescopic reflector includes a focusing element and a concave mirror, wherein the distance l between the focusing element and the concave mirror is determined by the expression l=(f+R), where f is the focal length of the focusing element and R is the curvature radius of the concave mirror.

13. The fibre laser according to claim 12 wherein the focusing element is either a lens or mirror.

14. A fibre laser with intra-cavity frequency doubling, comprising:
a pump source for generating pump radiation;
a doped optical fibre optically coupled to the pump source and positioned within a resonator formed by first and second dichroic mirrors, wherein the first dichroic mirror is configured to allow passage of the pump radiation and reflect a generated fundamental radiation, and wherein the second dichroic mirror is positioned outside the optical fibre and is configured to reflect the generated fundamental radiation;
a non-linear crystal positioned between the optical fibre and the second dichroic mirror; and
a plurality of focusing elements optically coupled to the fibre laser;
characterized in that the non-linear crystal is of type II phase matching thereby enabling operation of the fibre laser without selection of polarisation of the generated fundamental radiation, and wherein the non-linear crystal is oriented so as to minimise the walk-off angle of the second harmonic radiation, and wherein a spectral selector configured to narrow the radiation spectrum and stabilise the output power is positioned between the optical fibre and the non-linear crystal, and wherein a third cavity-folding output dichroic mirror configured to reflect the generated fundamental radiation and allow passage of the second harmonic radiation is also positioned between the optical fibre and the non-linear crystal, and wherein the second dichroic mirror together with one of the plurality of focusing elements forms a telescopic reflector that provides for focusing and compensation of the spatial walk-off effect of the non-linear crystal.

15. The fibre laser according to claim 14 wherein the spectral selector is either a Bragg grating integrated into the optical fibre's end, a filter, or an interferometer.

16. The fibre laser according to claim 14 wherein the non-linear crystal is a potassium titanium oxide phosphate (KTP) crystal.

17. The fibre laser according to claim 14 wherein the non-linear crystal is cut at an angle ranging from about 0° to 20° relative to the crystallographic axis of the non-linear crystal so as to allow for critical collinear phase matching.

18. The fibre laser according to claim 14 wherein the pump source comprises one or more laser diodes emitting at wavelengths of about 976 nm, 915 nm, or 808 nm, and wherein the output of the one or more laser diodes is guided into the optical fibre through a pump combiner.

19. The fibre laser according to claim 14 wherein the first dichroic mirror is integrated into the optical fibre as a fibre Bragg grating having a reflection spectrum ranging from about 0.03 nm to about 1 nm, and wherein the fibre Bragg grating is configured to allow for detuning of radiation wavelength either by application of (i) tension or compression to the part of the optical fibre where the fibre Bragg grating is positioned, or (ii) a temperature change to the fibre Bragg grating.

20. The fibre laser according to claim 14 wherein the optical fibre has a core diameter ranging from about 3 μm to about 100 μm.

21. The fibre laser according to claim 14 wherein the plurality of focusing elements include an aspherical lens, a gradient lens, a micro-lens, or a short-focus lens.

22. The fibre laser according to claim 14, further comprising:
a spectral selector configured to narrow the radiation spectrum and stabilise the output power positioned between the optical fibre and the non-linear crystal, wherein the spectral selector is either a Bragg grating integrated into the optical fibre's end, a filter, or an interferometer.

23. The fibre laser according to claim 14, further comprising:
a third cavity-folding output dichroic mirror configured to reflect the generated fundamental radiation and allow passage of the second harmonic radiation positioned between the optical fibre and the non-linear crystal, and wherein the second dichroic mirror is configured to reflect both the generated fundamental radiation and the second harmonic radiation.

24. The fibre laser according to claim 23 wherein one of the plurality of focusing elements is positioned between the third cavity-folding output dichroic mirror and the non-linear crystal.

25. The fibre laser according to claim 23, further comprising a narrow-band spectral selector integrated into the first, second, or third dichroic mirrors.

26. The fibre laser according to claim 14 wherein the telescopic reflector includes a focusing element and a concave mirror, wherein the distance l between the focusing element and the concave mirror is determined by the expression l=(f+R), where f is the focal length of the focusing element and R is the curvature radius of the concave mirror.

27. The fibre laser according to claim 26 wherein the focusing element is either a lens or mirror.
